(19) United States
(12) Patent Application Publication
(10) Pub. No.: US 2006/0115557 A1
(43) Pub. Date: Jun. 1, 2006

(54) Method of producing a folded-dough food product, industrial chain used for same and product thus obtained

(76) Inventors: Gerard Schlienger, Vittel (FR); Bernard Jacquemin, Chatenois (FR)

Correspondence Address: CLARK & BRODY, 1090 VERMONT AVENUE, NW, SUITE 250, WASHINGTON, DC, 20005, US

(21) Appl. No.: 10/515,646

(22) PCT Filed: Apr. 24, 2003
(86) PCT No.: PCT/FR03/01301

§ 371 Date: Jul. 29, 2005

(30) Foreign Application Priority Data
May 24, 2002 (FR) 02/06336

(51) Int. Cl. A21D 13/00

(52) U.S. Cl. 426/94

(57) ABSTRACT

The invention seeks to enable a heater or equivalent type food product to be eaten while hot and held in the hand, while retaining the heating qualities of the ingredients after heating. To do this, the invention proposes making a food product in application of the following steps: preparing uncooked dough (1) of the pizza or equivalent type, spreading it as a substantially rectangular basic slice that is twice the size of the product to be obtained; placing the various selected ingredients (7a, 7b) on the uncooked dough; cooking the dough with its ingredients in a pizza oven, on the floor and at the ambient temperature of said oven; on leaving the oven, folding the cooked and filled dough in half about a middle fold line forming a connecting spine (2) of continuous dough between two facing main faces (3a, 3b) that are substantially plane, with edges (3) of the faces being brought into alignment to define a side edge face (5) opposite from the connecting spine (2), and two end edge faces (6a, 6b), in a slice corresponding to the slice of the product that is to be obtained, and covering the side edge face and optionally no more than one of the end edge faces in an edible seam (4) for joining the edges together.

The invention relates to a method of manufacturing a food product comprising folded dough, to a manufacturing line for implementing the method, and to the food product obtained in this way.

### BACKGROUND OF THE INVENTION

A problem with food products of the pizza type, made of dough and of ingredients placed on the dough, lies in it being impossible to eat them while hot and when held in the hand, because of their size and their shape. Even when such products are subdivided into portions, they still do not lend themselves to being held in the hand and eaten decently while being held, since when they are hot the various ingredients are runny and can fall off.

This problem also occurs with food products that have been kept cold in a refrigerator, an ice box, or a deep freeze, and then reheated for eating on the spot.

Pizzas are also known that are in the form of turnovers in which the ingredients are enclosed in the dough and are cooked while smothered in the folded-over casing of dough. If the ingredients are to be cooked properly, then the casing of dough will be overcooked, and generally burns. In addition, cooking the ingredients while they are encased in the dough is detrimental to the eating qualities of the pizza. Furthermore, the substantially semicircular shape of the relatively floppy dough from which this type of pizza is made, and the fact that the ingredients are in a relatively semiliquid state and can therefore run, does not enable the product to be eaten hot while it is simultaneously being held in the hand.

Document FR 2 741 779 discloses a method of manufacturing a food product in the form of a case that can be eaten like a sandwich. That product requires precooking in two stages. It cannot be reheated properly for consumption while hot, since heating of the microwave type is not possible without spoiling the rigidity of the dough.

Document FR 2 791 527 describes a pizza type food product in the form of a pocket whose edges are closed together by an edible seam. In that case also, the food product cannot be properly reheated since that product is equivalent to the preceding product in terms of its behavior on reheating.

### OBJECTS AND SUMMARY OF THE INVENTION

The invention seeks to remedy the above-mentioned drawbacks, and in particular to enable a food product of the pizza or equivalent type to be eaten while hot and held in the hand, while preserving the heating qualities of the ingredients after they have been reheated.

To do this, the invention proposes making a food product in the form of dough that is folded in half while containing the ingredients, nevertheless leaving these ingredients freely accessible via at least one edge face.

More precisely, the invention provides a method of preparing a folded pastry food product, the method consisting in:
preparing uncooked pizza dough or equivalent type, spread in a substantially rectangular basic slice, twice the size of the product to be obtained;
placing the various selected ingredients on the uncooked dough;
cooking the dough with its ingredients in an oven having a floor and a vault, the dough being in contact with the floor and with the ambient heat of the vault;
folding the cooked filled dough in half on leaving the oven about a middle fold line so as to constitute a spine forming a continuous dough connection between two substantially plane facing main faces, with the edges of the main faces being put into alignment to define a side edge face opposite from the connecting spine, and two end edge faces, in a slice corresponding to that of the product that is to be obtained; and
covering the side edge face and any ingredients that might be flush therewith with an edible seam for joining the edges together.

The seam joining together the edges of the folded-over main faces may be a simple paste, obtained by mixing a cereal flour and water to obtain a viscosity that is appropriate for being applied in adherent manner to said edges, or else it can be an edible paste based on starch.

In a particular implementation, one of the end edge faces is also closed by an edible seam, the other end edge facing being left free without any edible seam.

Cooking the ingredients on the dough in the hot ambient air of the oven is cooking in the traditional manner and retains the heating qualities of conventional cooking. The folded-over structure of the dough that is closed along its side edge face serves to retain the ingredients sufficiently within the hardened dough without any risk of leakage, even when neither end edge face is provided with an edible seam.

Advantageously, while reheating by any conventional means such as a grill, toaster, spit, or oven, heat can penetrate easily through the end edge face(s) that is/are free, i.e. without an edible seam, thereby enabling the ingredients to be reheated all the way to the core of the product without it being necessary to overheat the outside.

The format of the resulting product may be that of a conventional handheld food item such as a sandwich or an apple turnover, and of dimensions that are appropriate for being held in the hand while being eaten.

The invention also provides a continuous industrial manufacturing line for implementing the above method, the line comprising the following operational stations in succession:
a station for preparing uncooked dough;
an extruder-glazer station for delivering the prepared uncooked dough as a continuous strip through an opening leading to a moving conveyor belt, the strip being of a width and a thickness that are determined by the opening;
at least one filler station for filling the strip of dough with ingredients that are laid to a calibrated thickness by being sprinkled and/or sprayed;
a cooking oven placed astride the conveyor belt for conveying the filled dough, in order to cook the dough continuously at a determined temperature and for a determined transit time;
a longitudinal cutting station for cutting the strip of dough into individual strips, and a transverse cutting station for producing substantially rectangular basic slices with the slices being separated from one another, where transverse cutting can be performed either immediately after longitudinal cutting, or else after a station for cooking edible seams placed on the end edge faces of the individual strips;
a folding station for folding the individual strips of cooked filled dough while hot and still flexible, this station being provided for each individual strip of dough with middle presser means and with vertical guides for causing the main faces that are formed by the folding using the middle presser means to stand up and face each other;
a station for delivering an edible seam at least over the side edge face formed between the substantially facing edges of the main faces of each of the folded basic slices, while they are being held in the vertical position by side plates;
a station for cooking and browning the edible seams in a transverse oven in order to cook and brown the seams to obtain dough forming a casing that is uniform and rigid; and
a station for cooling and packaging the resulting food products that are for eating after being reheated.

In particular embodiments:
each vertical upstanding guide is formed by a traveling ramp running between a horizontal drive axis and a vertical drive axis;
a pair of ramps is associated with each individual strip of dough, the ramps being symmetrical about the midplane presented by the individual strip of dough;
the filler station comprises two stations, a first station in which bottom sauce is sprinkled from a first hopper, and a second station from which other ingredients are deposited by being sprayed using a toothed drum driven in rotation from a second hopper;
in the cutting station, the cutting means are selected from cutter blades, ultrasound emitter devices, laser radiation devices, and high power water jets;
the edible seams on the basic slices are separated between slices by accelerating the conveyor belt after the station for putting the edible seam into place.

The invention also provides the food product made using the above-described method, in particular as implemented on the above-defined manufacturing line, in the form of a rectangular slice closed by an edible seam on the side edge face opposite from the connecting spine and formed between the main faces, and also, optionally, on no more than one of the end edge faces.

The product is stored deep-frozen, at a temperature less than or equal to −18° C., and is subsequently reheated prior to being eaten, by using any heater means, in particular a toaster, an infrared lamp, or an electrical resistance.

### BRIEF DESCRIPTION OF THE DRAWINGS

Other characteristics and advantages of the invention appear on reading the following embodiment of the invention described with reference to the accompanying figures, in which:

FIG. 1 is a perspective view of a food product of the invention in the form of a flat slab; and

FIG. 2 is a diagrammatic view of a production line for manufacturing the food product continuously.

### MORE DETAILED DESCRIPTION

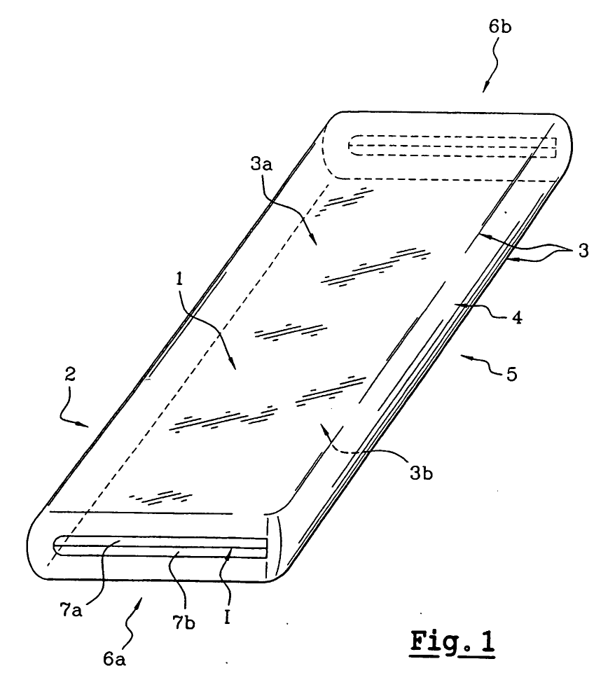

The food product as shown in FIG. 1 can be made non-industrially by hand, or industrially on a continuous manufacturing line.

For non-industrial preparation, a conventional dough is initially prepared, preferably an uncooked pizza dough 1 made of flour, water, salt, baking powder, icing sugar, and oil. All varieties of dough can be used, with varying proportions of flour and water, and with particular additives (eggs, butter, milk, fresh cream, etc.). For example, it is possible to use pancake or waffle batter, short pastry, cake mix, etc. depending on the type of product that is to be obtained, and in particular depending on the filling which might be sweet or savory.

The pizza dough is spread over a work surface as a substantially rectangular slice, approximately twice as wide as the finished product, e.g. having a width of about 15 centimeters (cm), a length of about 20 cm, and a thickness of about 1 millimeter (mm) to 2 mm. It may optionally be of a shape that is other than rectangular, but should nevertheless remain elongate.

The filling ingredients are then placed on it and spread in conventional manner, such as pouring on tomato sauce, and applying pieces of mushroom, cheese, diced bacon, artichoke, as desired. The dough is then put into a conventional pizza oven with a refractory floor and vault heated to about 400° C., and it is cooked for a period of one to two minutes. Cooking takes place at the ambient heat within the oven for the ingredients and by contact between the floor for the bottom dough 1.

Thereafter, the cooked dough and filler combination is taken out of the oven and put back onto the work surface. The hot, filled dough is then folded in half substantially along a middle longitudinal line defining the two halves of the dough. One half is folded onto the other using oven peels, one of the peels being used for supporting the first half and the other for folding the second half onto the first. The dough presents a spine 2 defining the longitudinal direction of the food product and interconnecting its two plane main faces 3a and 3b facing each other and substantially superposable. In so doing, the resulting product presents its final slice of a flat rectangular slab, having dimensions of about 7 cm×20 cm×1 cm.

A seam 4 of paste based on a mixture of flour and water is then applied to the side edge face 5 defined by the longitudinal edges 3 of the main faces extending parallel to the spine 2. The hot dough, still at 150° C. to 200° C., suffices to cook and thus harden the seam 4. Once the seam has hardened, not only does it retain the ingredients of the pizza in the pocket, but it also contributes to increasing the strength of the resulting product so as to enable it to be eaten in the hand.

The end edge faces 6a and 6b are not closed by an edible seam. These end edge faces thus enable the core of the product together with its ingredients to be reached during reheating prior to being eaten. The interface I between the two superposed layers 7a and 7b of ingredients then remains accessible to the outside, and heat easily reaches this interface from at least one end edge face.

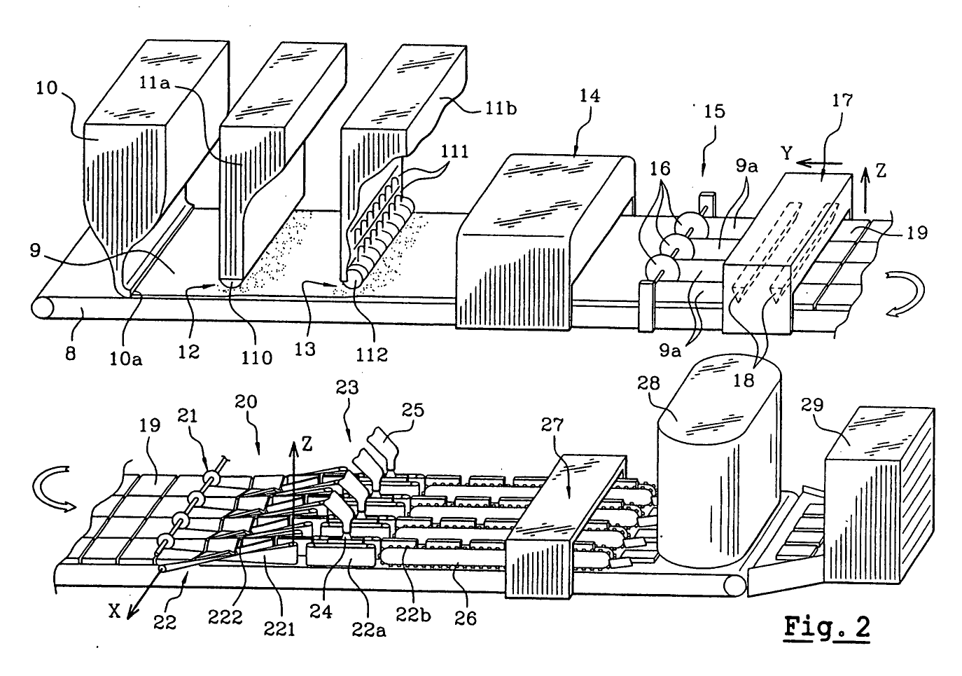

An example of a continuous industrial manufacturing line is shown in FIG. 2.

The manufacturing line shown comprises a moving conveyor belt 8 traveling at about two meters per minute, carrying a strip of dough 9 delivered by an extruder-glazer 10. This device is fed with pizza dough from a hopper, the dough being prepared upstream at a station situated separately. The strip of dough 9 is about 560 mm wide (after its edges have been delineated), i.e. eight times the width of the final product to be obtained (about 7 cm), and it is of calibrated thickness (lying in the range about 2 mm to 4 mm). This thickness is obtained through the outlet 10a of the device which is flush with the belt.

The belt then travels past two stations 11a and 11b for filling it with pizza ingredients. The first station 11a spreads tomato sauce 12, sprinkling the sauce from a first hopper provided with a perforated cylinder 110 turning on a fine-bristle brush and extending transversely. The layer is calibrated by the outlet opening which is flush with the strip of dough.

The other ingredients 13, e.g. pieces of various cheeses, ham, mushroom, or other fillings depending on the type of pizza (pieces of artichoke, bacon, etc.) are delivered from a second hopper at the station 11b, which is shown partially cut away. Deposition is performed by spraying as the strip advances using a staggered configuration of combs 111 coupled to a rotating outlet drum 112. The drum has teeth for calibrating the thickness of the layer. Advantageously, the drum turns in the opposite direction to the travel direction of the conveyor belt, so as to improve the regularity with which the ingredients are distributed.

The dough 9a filled in this way then passes through a tunnel oven 14 having a floor and a vault disposed below and above the belt, so as to be cooked in contact with the floor and at the ambient temperature of the oven vault which is about 400° C., and for a period of about 30 seconds (s) to 40 s. On leaving the oven, the temperature of the cooked filled dough lies in the range 70° C. to 80° C.

The filled strip is then passed through a first cutting station 15 which cuts it up into four individual strips 9a all having the same width (about 14 cm), using three cutter disks 16. The disks are disposed at regular intervals on a shaft extending transversely to the conveyor belt, with cutting taking place parallel to the travel direction of the dough. The presser exerted by the disk and the thickness of the disk are adjusted so as to ensure that the individual strips that are formed in this way are clearly separated from one another.

Cutting into basic slices, having the same length as the product that is to be made (about 20 cm), is performed in a second cutting station 17 having a guillotine with transverse knives 18 mounted to move tangentially along two axes Z-Y, i.e. vertically and horizontally, in the forward direction of the conveyor belt 8. The basic slices 19 as cut apart in this way and carrying their fillings are advantageously separated transversely from one another by small gaps (e.g. 1 cm to 2 cm) by causing the knives to come sequentially into abutment against the conveyor belt.

The cooked and filled slices while still hot (about 150° C. to 200° C.) and thus still flexible, then pass through a folding station 20. This station is fitted, for each individual strip of dough, with a middle presser disk 21 for splitting each slice into two main faces of equal area interconnected by the spine 2 which is made from the middle fold. Ramps 22 for folding vertically upwards start level with the presser disks on a roller having a transverse horizontal axis X, and are disposed longitudinally beneath the filled slice and are driven at the same speed as the conveyor belt. Each ramp is formed by a continuous strip forming a longitudinal loop, a driving first roller of horizontal axis X and a second roller of vertical axis Z mounted downstream in the conveyor belt travel direction.

The ramps 22 are organized in four pairs 221, 222 for folding up the basic slices 19 of the four individual strips of filled dough. The two ramps in any one pair are disposed symmetrically about a midplane P intersecting each individual strip and they are spaced apart at their vertical axes by an adjustable space, of about 1.5 cm in a non-limiting embodiment. In the travel direction of the conveyor belt, a pair of ramps fold up in succession the main faces 3a of the slices 19 facing each other, after they have been formed by folding using the middle presser disk 21. The main faces 3a of each slice are thus stood up vertically, edge to edge, in order to form a product constituted by a flat slab with the side edge face 5 opposite from the spine 2.

The basic slices as stood up vertically in this way, and as held laterally by side plates, other vertical ramps, or by holders 22a, as shown, present their side edge faces horizontally at a station 23 for laying an edible joint. In this station, a seam of paste 24 based on starch is deposited via four devices 25 having ejector nozzles so as to cover the side edge faces 5 continuously.

This paste may be obtained as a mixture of wheat flour and water, possibly together with other additives (e.g. coloring agents). It is applied with the required degree of viscosity. The seam 24 adheres to the dough and to the ingredients that are flush therewith. In order to detach the seam cleanly from each side edge face, the slices are advantageously accelerated on a conveyor belt 26 provided with lateral holders 22a for holding the main faces of the slices vertical.

The basic slices with their seams are then passed through a transverse infrared oven 27 for cooking and browning the seams using dedicated wavelengths. In addition, the entire dough of the food product made in this way is hardened and made more uniform.

On the manufacturing line described by way of example, it is possible to produce 3000 products per hour. The length of the line is sufficient to enable the products to cool down and avoid excessive thermal shock during a subsequent stage of deep freezing.

The food products laid flat on the conveyor belt are cooled to −25° C. in a deep-freezing chamber 28 prior to reaching a final packaging and storage station 29 for the product. In this station, the products are put into boxes, the boxes are closed by adhesive, and then stored in a cold chamber at −18° C.

The resulting product can be eaten in the hand without risk of leakage, once it has been reheated. Because of the openings in the end edge faces, the ingredients and fillers in the food products can be eaten at an ideal temperature.

The invention is not limited to the embodiments described and shown. Numerous variant embodiments are possible without going beyond the invention, e.g. concerning the polygonal shape of the food product, the various recipes used for the pastry and the ingredients constituting a sweet or savory filler, the various adaptations of the manufacturing line, e.g. preparing the dough continuously in a mixer or monitoring the operations performed and the workstations by means of temperature, presser, and/or humidity sensors, connected to a central monitoring unit.

In addition, the conveyor belt may be formed as a single belt over the entire length of the manufacturing line, or it may be built up from a plurality of juxtaposed sectors dedicated to particular workstations in the line. At the station for putting the paste seam into place, it is possible to form a joint on the side edge face and on one of the end edge faces of each basic slice, by tilting the conveyor belt at 45° relative to the horizontal plane of the installation at a suitable distance, or by likewise tilting the paste delivery nozzle by 45°. In addition, the dough can be cut longitudinally into individual strips prior to the dough and its ingredients being cooked.

1. A method of preparing a folded pastry food product, the method consisting in:
preparing uncooked dough (1) of pizza or equivalent type, spread in a substantially rectangular basic slice, twice the size of the product to be obtained;
placing the various selected ingredients (7a, 7b) on the uncooked dough;
cooking the dough with its ingredients in an oven having a floor and a vault, the dough being in contact with the floor and with the ambient heat of the vault;
folding the cooked filled dough in half on leaving the oven about a middle fold line so as to constitute a spine (2) forming a continuous dough connection between two substantially plane facing main faces (3a, 3b), with the edges (3) of the main faces being put into alignment to define a side edge face(5) opposite from the connecting spine (2), and two end edge faces (6a, 6b), in a slice corresponding to that of the product that is to be obtained; and
covering the side edge face (5) and any ingredients that might be flush therewith with an edible seam (4) for joining the edges together.

2. A method of manufacture according to claim 1, in which one of the end edge faces (6a, 6b) is also closed by an edible seam, the other end edge facing being left free without any edible seam.

3. An industrial continuous manufacturing line for implementing the method according to claim 1, the manufacturing line comprising the following operating stations in succession:
a station for preparing uncooked dough;
an extruder-glazer station (10) for delivering the prepared uncooked dough as a continuous strip (9) through an opening (10a) leading to a moving conveyor belt (8), the strip being of a width and a thickness that are determined by the opening (10a);
at least one filler station (11a, 11b) for filling the strip of dough (9) with ingredients (12, 13) that are laid to a calibrated thickness by being sprinkled and/or sprayed;
a cooking oven (14) placed astride the conveyor belt (8) for conveying the filled dough, in order to cook the dough continuously at a determined temperature and for a determined transit time;
a longitudinal cutting station (15) for cutting the strip of dough (9) into individual strips (9a), and a transverse cutting station (17) for producing substantially rectangular basic slices (19) with the slices being separated from one another;
a folding station (20) for folding the individual strips (9a) of cooked filled dough while hot and still flexible, this station being provided for each individual strip of dough (9a) with middle presser means (21) and with vertical guides for causing the main faces (3a, 3b) that are formed by the folding using the middle presser means (21) to stand up and face each other;
a station (23) for delivering an edible seam (24) at least over the side edge face (5), as well as, optionally, at the most, over one of the end edge faces (6a, 6b), formed between the substantially facing edges (3) of the main faces (3a) of each of the folded basic slices, while they are being held in the vertical position by side plates (22a);
a station for cooking and browning the edible seams in a transverse oven (27) in order to cook and brown the seams (24) to obtain dough forming a casing that is uniform and rigid; and
a station for cooling (28) and packaging (29) the resulting food products that are for eating after being reheated.

4. An industrial continuous manufacturing line for implementing the method according to claim 1, the manufacturing line comprising the following operating stations in succession:
a station for preparing uncooked dough;
an extruder-glazer station (10) for delivering the prepared uncooked dough as a continuous strip (9) through an opening (10a) leading to a moving conveyor belt (8), the strip being of a width and a thickness that are determined by the opening (10a);
at least one filler station (11a, 11b) for filling the strip of dough (9) with ingredients (12, 13) that are laid to a calibrated thickness by being sprinkled and/or sprayed;
a cooking oven (14) placed astride the conveyor belt (8) for conveying the filled dough, in order to cook the dough continuously at a determined temperature and for a determined transit time;
a longitudinal cutting station (15) for cutting the strip of dough (9) into individual strips (9a);
a folding station (20) for folding the individual strips (9a) of cooked filled dough while hot and still flexible, this station being provided for each individual strip of dough (9a) with middle presser means (21) and with vertical guides for causing the main faces (3a, 3b) that are formed by the folding using the middle presser means (21) to stand up and face each other;
a station (23) for delivering an edible seam (24) at least over the side edge face (5), as well as, optionally, at the most, over one of the end edge faces (6a, 6b), formed between the substantially facing edges (3) of the main faces (3a) of each of the folded basic slices, while they are being held in the vertical position by side plates (22a);
a station for cooking and browning the edible seams in a transverse oven (27) in order to cook and brown the seams (24) to obtain dough forming a casing that is uniform and rigid;
a transverse cutting station (17) for making substantially rectangular basic slices (19), with said slices and their edible seams (24) being separated; and
a station for cooling (28) and packaging (29) the resulting food products that are for eating after being reheated.

5. A manufacturing line according to claim 3, in which each vertical upstanding guide (22) is formed by a traveling ramp running between a horizontal drive axis (X) and a vertical drive axis (Z).

6. A manufacturing line according to claim 5, in which a pair of ramps (221, 222) is associated with each individual strip of dough (9a), the ramps being symmetrical about the midplane (P) presented by the individual strip of dough.

7. A manufacturing line according to claim 3, in which the filler station comprises two stations, a first station (11a) for laying a bottom sauce which is sprinkled from a first hopper, and a second station (11b) for sprinkling the other ingredients which are driven from a second hopper by being sprayed using a rotating toothed drum (112).

8. A manufacturing line according to claim 3, in which, in the longitudinal and transverse cutting station (17), the cutter means are selected from cutter blades, ultrasound emitter devices, laser radiation devices, and high presser water jets (Y, Z) for the transverse cutting.

9. A manufacturing line according to claim 3, in which the edible strips on the basic slices (19) are detached between slices by accelerating the conveyor belt (26) after the station (23) for putting the edible seam into place.

10. A food product obtained by the manufacturing method according to claim 1, and in particular as implemented by a manufacturing line according to claim 3, having a rectangular slice closed by an edible seam (4) on the side edge face (5) opposite from the connecting spine (2) and formed between the main faces (3a), and also, optionally, on no more than one of the end edge faces (6a, 6b).
